(19) United States
(12) Patent Application Publication
(10) Pub. No.: US 2015/0339796 A1
(43) Pub. Date: Nov. 26, 2015

(54) APPARATUS AND METHOD FOR CONTROLLING VIDEO OUTPUT OF AUDIO VIDEO NAVIGATION SYSTEM

(71) Applicant: HYUNDAI MOBIS CO., LTD., Seoul (KR)

(72) Inventor: Hong Youl LIM, Yongin (KR)

(21) Appl. No.: 14/619,028

(22) Filed: Feb. 10, 2015

(30) Foreign Application Priority Data
May 20, 2014 (KR) 10-2014-0060208

(51) Int. Cl. G06T 1/20; G06F 3/041; G09G 3/36

(52) U.S. Cl. CPC G06T 1/20; G09G 3/36; G06F 3/0412; G09G 2320/0613; G09G 2340/02; G09G 2360/10; G09G 2370/14

(57) ABSTRACT

The present invention provides an apparatus for controlling a video output of an audio video navigation (AVN) system, including: a display unit which displays a video in the AVN system; a signal dividing unit which divides an input first signal, transmits the video to the display unit using a second signal obtained by dividing the first signal and senses a user input on the display unit using a third signal obtained by dividing the first signal; and a video output control unit which controls an output of a video which conforms with a predetermined standard, using the first signal and controls an output of a video corresponding to the user input.

### CROSS-REFERENCE TO RELATED APPLICATIONS

This application claims priority to and the benefit of Korean Patent Application No. 10-2014-0060208 filed in the Korean Intellectual Property Office on May 20, 2014, the entire contents of which are incorporated herein by reference.

### TECHNICAL FIELD

The present invention relates to an apparatus and a method for controlling a video output, and more particularly, to an apparatus and a method for controlling a video output of an audio video navigation (AVN) system in a vehicle.

### BACKGROUND ART

In order to correspond to a separable monitor product in the AVN system, a hardware is configured such that when a video signal is transmitted from a CPU to a display driving board through a serializer, the compressed video signal is uncompressed in the display driving board to be transmitted to an LCD panel.

Further, according to a general product configuration of an AVN system of the related art, since a touch panel is included in a display device, an exclusive touch IC is installed in the display driving board to control the touch panel and a touch coordinate is obtained using CAN communication between a CPU and an MCU,

However, the AVN system of the related art has the following problems.

First, the MCU is added to the display driving board but the MCU performs only limited functions, such as CPU interfacing or other LCD power sequence controlling.

Second, even though the CPU directly controls the touch IC, when a line becomes longer, it causes a communication error so that it is difficult to directly control the touch IC. Therefore, in the related art, an indirect control method is applied to control the touch IC through the MCU.

Third, in addition to a deserializer, an MCU is added, which may increase a material cost.

Korean Registered Patent No. 941,647 discloses a control method of an AVN system. However, this control method is a method for watching, listening, or scheduled recording of a specific broadcasting by selecting a broadcasting channel so that the method cannot solve the above-mentioned problems.

### SUMMARY OF THE INVENTION

The present invention has been made in an effort to provide an apparatus and a method for controlling a video output of an AVN system in which a circuit is configured such that a limited function of an MCU of a circuit configuration of a separable monitor of the AVN is installed in a video signal transmitting deserializer to be directly controlled by a CPU.

However, an object of the present invention is not limited to the above description and other objects which have not been mentioned above will be more apparent to those skilled in the art from a reading of the following description.

An exemplary embodiment of the present invention provides an apparatus for controlling a video output of an audio video navigation (AVN) system, including: a display unit which displays a video in the AVN system; a signal dividing unit which divides an input first signal, transmits the video to the display unit using a second signal obtained by dividing the first signal and senses a user input on the display unit using a third signal obtained by dividing the first signal; and a video output control unit which controls an output of a video which conforms with a predetermined standard, using the first signal and controls an output of a video corresponding to the user input.

The signal dividing unit may be implemented by a deserializer which receives the first signal as a serial signal and generates the second signal and the third signal as parallel signals.

The apparatus may further include a control signal combining unit which combines control signals generated by the video output control unit to generate the first signal and transmits the first signal to the signal dividing unit through a signal route.

The control signal combining unit may generate a low voltage differential signaling (LVDS) signal as the first signal.

A first board which includes the video output control unit and the control signal combining unit may include the signal dividing unit and is formed to be separated from a second board which is installed in the display unit.

The video output control unit may control a power sequence of the display unit together using the first signal.

The video output control unit may use an inter-integrated circuit (I2C) to sense the user input on the touch panel which is located on a front surface of the display unit.

Further, another exemplary embodiment of the present invention provides a method for controlling a video output of an AVN system, including: combining control signals for an AVN system to generate a first signal; transmitting the first signal through a single route; dividing the first signal; and controlling an output of a video which complies with a predetermined standard using a second signal obtained by dividing the first signal and controlling an output of a video corresponding to the user input in the display device using the third signal obtained by dividing the first signal.

The method may further include controlling a power sequence of the display device using a fourth signal obtained by dividing the first signal as a step which is simultaneously performed with the controlling of an output.

In the dividing, the first signal may be received as a serial signal and the second signal and the third signal may be generated as parallel signals.

The generating may include generating a low voltage differential signaling (LVDS) signal as the first signal.

The method may further include sensing the user input on a touch panel which is located on a front surface of the display device using an inter-integrated circuit (I2C) as a step which is simultaneously performed with the controlling of an output.

According to the exemplary embodiment of the present invention, a circuit is configured such that a limited function of an MCU among a circuit configuration of a separable monitor of an AVN is installed in a video signal transmitting deserializer to be directly controlled by a CPU, thereby achieving the following advantages.

First, a configuration of a CPU, an MCU, and a touch panel is changed to a direct control type of a CPU and a touch panel so that communication delay between devices disappears, thereby increasing control efficiency.

Second, when a CPU software is controlled, a CAN bus line and a protocol allocation are not necessary, thereby reducing CPU resources.

Third, the significant number of peripheral circuit components including a single component of an MCU may be reduced.

Fourth, since a cost percentage of the MCU is large in the display driving board, when in addition to the MCU, a considerable amount of other additional circuits may be removed, reduced material cost is significant.

### BRIEF DESCRIPTION OF THE DRAWINGS

FIG. 1 is a circuit diagram of an AVN separable monitor according to a first exemplary embodiment of the present invention.

FIG. 2 is a circuit diagram of an AVN separable monitor according to a second exemplary embodiment of the present invention.

FIG. 3 is a view illustrating a compression format of a signal which is transmitted by a serializer to a deserializer according to an exemplary embodiment of the present invention.

FIG. 4 is a block diagram schematically illustrating a video output control apparatus of an AVN system according to an exemplary embodiment of the present invention.

FIG. 5 is a flowchart illustrating a video output control method of an AVN system according to an exemplary embodiment of the present invention.

### DETAILED DESCRIPTION OF THE INVENTION

Hereinafter, exemplary embodiments of the present invention will be described in detail with reference to the accompanying drawings. In the figures, even though the parts are illustrated in different drawings, it should be understood that like reference numbers refer to the same or equivalent parts of the present invention throughout the several figures of the drawing. Furthermore, when it is judged that specific description on known configurations or functions related in the description of the present invention may unnecessarily obscure the essentials of the present invention, the detailed description will be omitted. Further, hereinafter, exemplary embodiments of the present invention will be described. However, it should be understood that the technical spirit of the invention is not limited to the specific embodiments, but may be changed or modified in various ways by those skilled in the art.

According to an exemplary embodiment of the present invention, an MCU and a communication related peripheral circuit are removed using a video signal transmitting chip of an audio video navigation (AVN) separable monitor so that a circuit configuration of the separable monitor is simplified, thereby improving control efficiency and reducing a material cost.

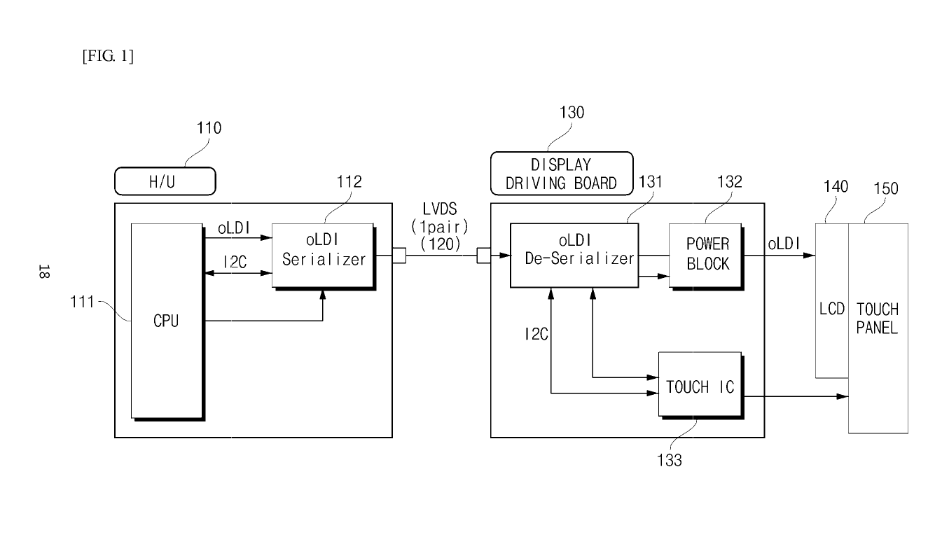

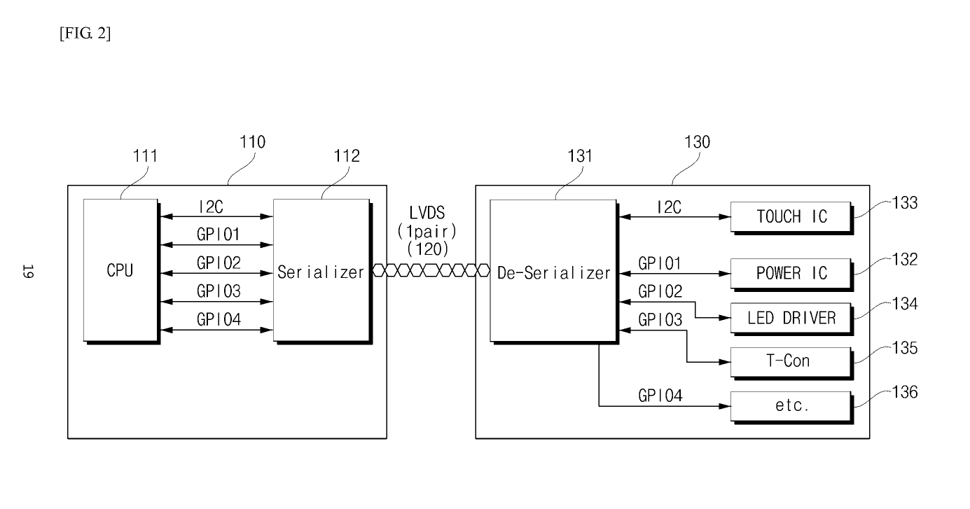

FIGS. 1 and 2 are circuit diagrams of an AVN separable monitor according to an exemplary embodiment of the present invention which is more simplified than the related art.

A circuit configuration of a separable monitor according to an exemplary embodiment of the present invention has the following advantages.

First, a circuit is configured so as to be directly controlled by a CPU 111.

Second, an inter-integrated circuit (I2C) communication is implemented between the CPU 111 and a serializer 112.

Third, a limited function of the MCU is covered by using video signal transmitting chips 112 and 131 of the separable monitor so that the MCU and the communication related peripheral circuit are removed.

FIGS. 1 and 2 illustrate a circuit configuration in which a CPU 111 on an H/U 110 transmits a video signal and a control signal together using a low voltage differential signaling (LVDS) 120 so as to directly control a display driving board 130 in addition to a touch IC 133.

A circuit is configured such that a limited function of the MCU of the circuit configuration of a separable of an AVN of the related art is installed in a video signal transmitting deserializer 131 to be directly controlled by the CPU 111. Accordingly, control efficiency between the CPU 111 and the touch IC 133 is increased and an MCU, a controller area network (CAN) transceiver, and a related component may be removed from a display driving board 130 so that competitiveness in price of the product may be increased.

When a hardware is configured as illustrated in FIGS. 1 and 2, the MCU on the display driving board 130 may be removed and a touch control signal I2C and an additional control signal GPIO may be transmitted together with a LVDS signal between the serializer 112 and the deserializer 131 so that the MCU function may be directly controlled by the CPU 111 using the LVDS signal.

Effects of the present invention according to the first exemplary embodiment of FIG. 1 and the second exemplary embodiment of FIG. 2 will be summarized as follows: First, the MCU, a transceiver circuit block for CAN communication, a CAN communication wire, and other additional circuit which are provided on the monitor circuit may be removed.

Second, in addition to the touch IC communication I2C, a power sequence function (GPIO) which is performed by the MCU and other control signals may be also controlled by the deserializer 131.

FIG. 1 illustrates control of the touch panel 150 through the touch IC 133 and power sequence control of an LCD panel 140 through the power block 132 and FIG. 2 illustrates other controls of an LED driver 134, a T-con 135, and other additional circuit 136 in addition to the two control of FIG. 1. In the above description, the T-con 135 refers to a timing controller IC which optimizes a video signal which is input through the LCD module to be transmitted to a gate driver IC and a source driver IC mounted in the LCD panel 140, thereby achieving a high quality image.

Third, without using the MCU which controls the AVN separable monitor, the control signal of the CPU 111 may be directly controlled by the CPU 111 using a video signal transmitting IC. The present invention adopts a method of transmitting the CPU control signal GPIO to be included in the video transmitting signal LVDS.

Fourth, the CPU 111 may directly access not only the serializer 112 but also an internal controller register of the deserializer 131 through the I2c and the control signal GPIO of the CPU 111 which is input or output to or from the serializer 112 is reflected in real time so that the same effect as it is directly controlled by the CPU 111 may be obtained.

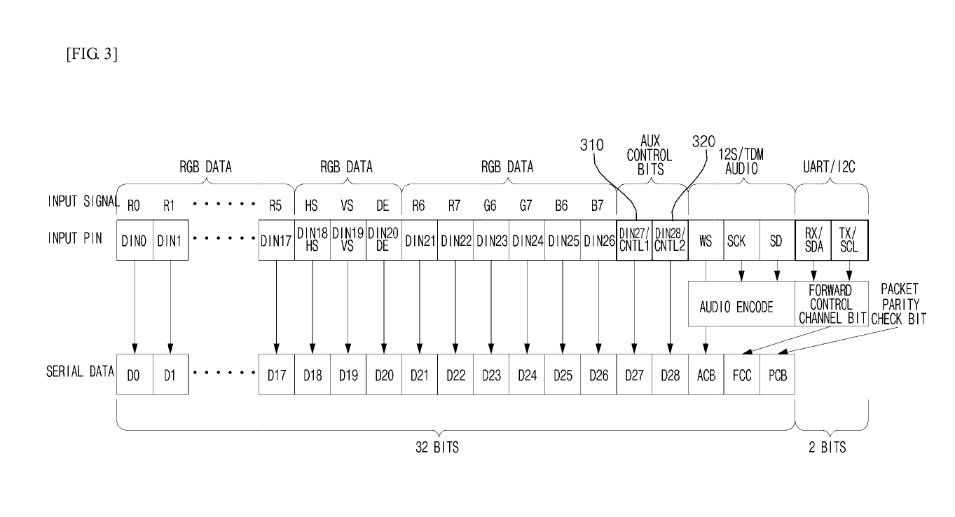

FIG. 3 is a view illustrating a compression format of a signal which is transmitted by a serializer to a deserializer according to an exemplary embodiment of the present invention.

A compression format at a serializer stage is configured by total 34 bits including a video, an I2C, and a GPIO, as illustrated in FIG. 3 and one video pixel data information is loaded in DIN 0 to 26 to be transmitted and DIN27 310 and DIN28 320 may be used as the GPIO signal.

The LVDS signal transmitted as described above decodes a video which is compressed again at a deserializer stage to restore an original video signal and reproduce a video signal required for a display device.

It is disclosed that a data format which is transmitted from a IC of a serializer which is provided on a head unit in FIG. 3. Referring to FIG. 3, a deserializer which is provided on a circuit board of a display device restores a compressed signal included a image based on the data format to a parallel signal. The deserializer can use a specific bit (for example, DIN27 310 and DIN28 320) which is additionally allocated in addition to the compressed signal when the deserializer operates as a GPIO.

In the related art, the MCU serves to control a power sequence of an LCD, implement communication with a CPU of a head unit, and transmit a touch IC signal to the head unit. Accordingly, the connector just transmits a video signal.

In the present invention, a touch signal for controlling the touch IC and the LCD video signal are serially converted to be transmitted to the connector together with the video signal and instead of removing the MCU, the deserializer transmits the touch signal to the CPU and transmits the control signal of the CPU to control the LCD power sequence.

As described above, according to the exemplary embodiment of the present invention, the MCU on the AVN monitor of the related art may be removed and even though the MCU is removed, the CPU may directly control the function which is performed by the MCU using the deserializer, thereby optimizing a circuit resource.

The exemplary embodiment of the present invention described above with reference to FIGS. 1 to 3 may be applied to a separable monitor circuit of a D-audio platform.

An exemplary embodiment of the present invention has been described above with reference to FIGS. 1 to 3. Hereinafter, an exemplary embodiment of the present invention based thereon will be described.

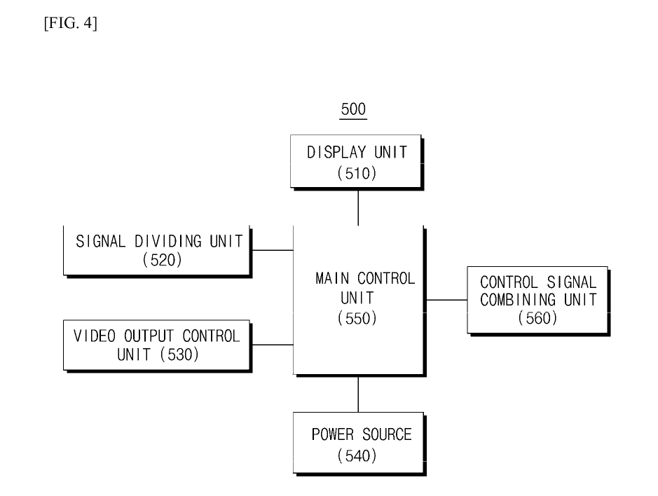

FIG. 4 is a block diagram schematically illustrating a video output control apparatus of an AVN system according to an exemplary embodiment of the present invention.

Referring to FIG. 4, a video output control apparatus 500 of an AVN system includes a display unit 510, a signal dividing unit 520, a video output control unit 530, a power supply 540, and a main control unit 550.

The power supply 540 supplies a power to individual components of the video output control apparatus 500. The main control unit 550 controls the overall operation of individual components of the video output control apparatus 500. When considering that the video output control apparatus 500 is provided in an automobile AVN system, the power supply 540 and the main control unit 550 may not be provided in the exemplary embodiment.

The display unit 510 displays a video in the AVN system.

The display unit 510 is the same concept as the LCD 140 of FIG. 1.

The signal dividing unit 520 divides an input first signal and transmits a video to the display unit using a second signal obtained by dividing the first signal, and senses a user input in the display unit 510 using a third signal obtained by dividing the first signal.

The signal dividing unit 520 may be implemented by a deserializer which receives the first signal as a serial signal and generates the second signal and the third signal as parallel signals.

The video output control unit 530 controls an output of a video which conforms to a predetermined standard, using the first signal and controls an output of a video corresponding to the user input. The video output control unit 530 also controls a touch sensor so as to sense the user input.

The video output control unit 530 also controls the power sequence of the display unit 510 using the first signal.

The video output control unit 530 senses the user input with respect to the touch panel which is located on a front surface of the display unit 510 using the inter-integrated circuit (I2C).

The video output control unit 530 is the same concept as the CPU 111 of FIGS. 1 and 2.

The video output control device 500 may further include a control signal combining unit 560.

The control signal combining unit 560 combines control signals which are generated by the video output control unit 530 to generate a signal and transmits the first signal to the signal dividing unit 520 through a single route.

The control signal combining unit 560 may generate a low voltage differential signaling (LVDS) signal as the first signal. The control signal combining unit 560 is the same concept as the serializer 112 of FIGS. 1 and 2.

In the meantime, in the exemplary embodiment, a first board which includes the video output control unit 530 and the control signal combining unit 560 may be formed to be separated from a second board which includes the signal dividing unit 520. The second board is installed in the display device.

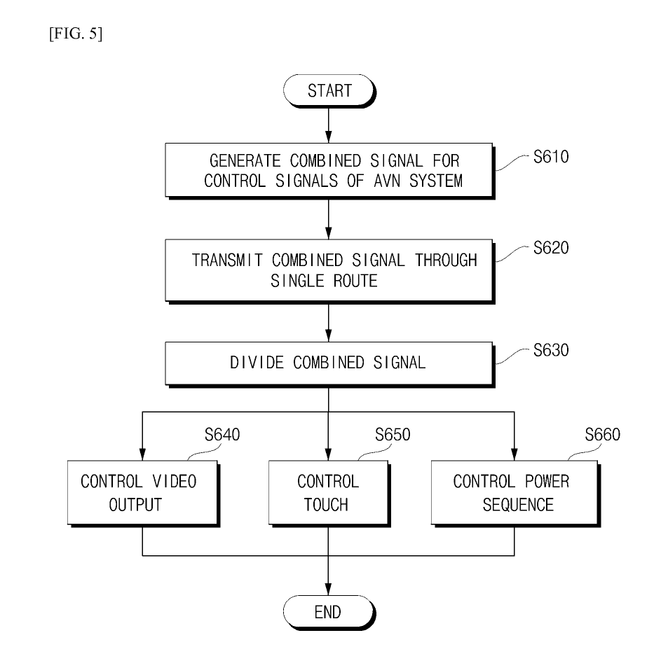

Next, an operating method of the video output control apparatus 500 of the AVN system will be described. FIG. 5 is a flowchart illustrating a video output control method of an AVN system according to an exemplary embodiment of the present invention. The following description will be made with reference to FIGS. 4 and 5.

First, the control signal combining unit 560 combines control signals for an AVN system to generate a first signal in step S610. Next, the control signal combining unit 560 transmits the first signal through a single route in step S620. When the first signal is received, the signal dividing unit 520 divides the first signal in step S630.

Next, the video output control unit 530 controls an output of a video which complies with a predetermined standard using the second signal obtained by dividing the first signal and controls an output of a video corresponding to a user input in a display device using a third signal obtained by dividing the first signal in step S640.

Further, the video output control unit 530 uses the I2C to sense a user input on a touch panel which is located on a front surface of the display device in step S650 and also controls a power sequence of the display device using a fourth signal obtained by dividing the first signal in step S680.

Even though step S660 may be performed simultaneously with step S640, step S660 may be performed between step S630 and step S640 or performed later than step S640. Of course, step S650 is the same as step S660.

Even though it has been described above that all components of the exemplary embodiment of the present invention are combined as one component or operate to be combined, the present invention is not limited to the exemplary embodiment. In other words, one or more components may be selectively combined to be operated within a scope of the present invention. Further, all components may be implemented as one independent hardware but a part or all of the components are selectively combined to be implemented as a computer program which includes a program module which performs a part or all functions combined in one or plural hardwares. Further, such a computer program may be stored in a computer readable media such as a USB memory, a CD disk, or a flash memory to be read and executed by a computer to implement the exemplary embodiment of the present invention. The recording media of the computer program may include a magnetic recording medium, an optical recording medium, or a carrier wave medium.

If it is not contrarily defined in the detained description, all terms used herein including technological or scientific terms have the same meaning as those generally understood by a person with ordinary skill in the art. A generally used terminology which is defined in a dictionary may be interpreted to be equal to a contextual meaning of the related technology but is not interpreted to have an ideal or excessively formal meaning, if it is not apparently defined in the present invention.

The above description illustrates a technical spirit of the present invention as an example and various changes, modifications, and substitutions become apparent to those skilled in the art within a scope of an essential characteristic of the present invention. Therefore, as is evident from the foregoing description, the exemplary embodiments and accompanying drawings disclosed in the present invention do not limit the technical spirit of the present invention and the scope of the technical spirit is not limited by the exemplary embodiments and accompanying drawings. The protection scope of the present invention should be interpreted based on the following appended claims and it should be appreciated that all technical spirits included within a range equivalent thereto are included in the scope of the present invention.

What is claimed is:

1. An apparatus for controlling a video output of an audio video navigation (AVN) system, comprising:
a display unit which displays a video in the AVN system;
a signal dividing unit which divides an input first signal, transmits the video to the display unit using a second signal obtained by dividing the first signal and senses a user input on the display unit using a third signal obtained by dividing the first signal; and
a video output control unit which controls an output of a video which conforms with a predetermined standard, using the first signal and controls an output of a video corresponding to the user input.

2. The apparatus of claim 1, wherein the signal dividing unit is a deserializer which receives the first signal as a serial signal and generates the second signal and the third signal as parallel signals.

3. The apparatus of claim 1, further comprising:
a control signal combining unit which combines control signals generated by the video output control unit to generate the first signal and transmits the first signal to the signal dividing unit through a signal route.

4. The apparatus of claim 3, wherein the control signal combining unit generates a low voltage differential signaling (LVDS) signal as the first signal.

5. The apparatus of claim 3, wherein a first signal including the video output control unit and the control signal combining unit includes the signal dividing unit and is separately formed from a second board which is mounted in the display unit.

6. The apparatus of claim 1, wherein the video output control unit also controls a power sequence of the display unit using the first signal.

7. The apparatus of claim 1, wherein the video output control unit uses an inter-integrated circuit (I2C) to sense the user input on the touch panel which is located on a front surface of the display unit.

8. A method for controlling a video output of an AVN system, comprising:
combining control signals for an AVN system to generate a first signal;
transmitting the first signal through a single route;
dividing the first signal; and
controlling an output of a video which complies with a predetermined standard using a second signal obtained by dividing the first signal and controlling an output of a video corresponding to the user input in the display device using the third signal obtained by dividing the first signal.

9. The method of claim 8, further comprising:
a power sequence of the display device using a fourth signal obtained by dividing the first signal.

10. The method of claim 8, wherein in the dividing, the first signal is received as a serial signal and the second signal and the third signal are generated as parallel signals.

11. The method of claim 8, wherein the generating includes generating a low voltage differential signaling (LVDS) signal as the first signal.

12. The method of claim 8, further comprising:
sensing the user input on a touch panel which is located on a front surface of the display device using an inter-integrated circuit (I2C).
